(19) United States
(12) Patent Application Publication
(10) Pub. No.: US 2019/0078733 A1
(43) Pub. Date: Mar. 14, 2019

(54) GAS STEEL CONTAINER STRUCTURE FOR CARS

(71) Applicant: ALEX GLOBAL TECHNOLOGY, INC., Tainan City (TW)

(72) Inventor: WEI-CHIN CHEN, TAINAN CITY (TW)

(21) Appl. No.: 15/699,208

(22) Filed: Sep. 8, 2017

(51) Int. Cl. F17C 1/14

(52) U.S. Cl. CPC F17C 1/14; F17C 2201/0138; F17C 2203/0646; F17C 2260/011; F17C 2205/0311; F17C 2221/035; F17C 2270/0178; F17C 2203/0648

(57) ABSTRACT

This invention relates a gas steel container structure for cars, comprising two lateral components, plural intermediate components, plural bonding components, an upper lid and a lower lid. The lateral components are disposed at two sides of the present invention, and each of the lateral components has connectors at two sides. The intermediate components are disposed between the lateral components and each intermediate component has two engaging portions disposed at two sides thereof. The two engaging portions are corresponding to the two connectors or to the two engaging portions of another intermediate component. The plural bonding components are provided to connect the lateral components and the intermediate components, each bonding component has plural locking portions at two sides thereof to interlock with the upper lid and the lower lid correspondingly to form a gas steel container structure for cars.

### BACKGROUND OF THE INVENTION

### 1. Field of the Invention

The present invention relates to a gas steel container structure for cars which has a high structural strength and air-tight structures in avoidance of air leaks in use.

### 2. Description of Related Art

Recently, for environmental and economic reasons, liquefied petroleum gas (LPG) having much complete combustion than gasoline is primarily used as vehicle fuels in Japan, the United States, Australia, South Korea, Italy, the Netherlands and other countries for saving energy. Therefore, the modified gas cars considered illegal in the past are promoted by the authority nowadays to facilitate the replacement of gasoline by gas as power source for millions of vehicles. Furthermore, the authority also plans to build up gas filling stations widely and to subsidize for gas car modification for achieving the purpose of universalizing the gas cars. However, gas cars are prone to exploding when they move on the road, which is a problem to be solved.

It is learned that the cars modified to use liquefied petroleum gas (LPG) are called gas vehicles, and the bi-fuel vehicles are the cars which can use petrol fuel or LPG fuel as power source. Currently, the so called bi-fuel vehicles on the market are all provided with a dual fuel system which can switch to use petrol fuel or LPG fuel. In the gas vehicles, the structures of the steel containers for storing LPG must be much rigid and impact resistant than the oil tanks. In general, a steel plate of the main girder of a car has a thickness of 1.1 mm while the LPG steel container has a thickness of 3 mm. The LPG steel containers can be divided into two types including horizontal-form and vertical-form steel containers depending on the size of the installation space. In order not to affect the luggage space, the horizontal-form steel containers are usually utilized in the gas vehicles.

In terms of the structure of a LPG high-pressure steel container, it mainly composed of a fill valve, an output valve, a safety valve, a liquid level indicator and the like. Furthermore, a LPG steel container is also provided with various kinds of safety valves. The LPG steel containers have ability of automatic filling 80% of gas in themselves and can bear pressure of more than 30 kg/cm², so they are rigid and durable. Though the tested and certified LPG steel containers have much safety design than the oil tanks, they still have many problems to be solved. For instance, it is difficult to control quality of the steel containers due to being manufactured by welding, and there is still a need to increase the usage security of the gas vehicles.

### SUMMARY OF THE INVENTION

The major purpose of the present invention is to provide a gas steel container structure for cars, which has a high structural strength in avoidance of air leaks in use.

The major purpose and the effects of the gas steel container structure for cars in the present invention are achieved particularly by the following technical features:

The gas steel container structure for cars in the present invention comprises two lateral components, plural intermediate components, plural bonding components, an upper lid and a lower lid. The two lateral components are disposed at two sides of the present invention respectively, and each or the two lateral components has two connectors disposed on two sides thereof. Plural intermediate components are disposed between the two lateral components, and each of the plural intermediate components has two engaging portions disposed at two sides thereof. The two engaging portions are corresponding to the two connectors or to the two engaging portions of another intermediate component. The plural bonding components are provided to connect the two lateral components and the plural intermediate components, each of the plural bonding components has at least one locking portion for interlocking with the upper lid and the lower lid to form a gas steel container structure for cars. Therefore, the gas steel container structure for cars of the present invention has structural strength by connection of the components and achieve efficacy of usage security with no air leaks in use.

According to an embodiment of the present invention, each of the plural the bonding components has two linkage portions at two sides, and each of the two linkage portions links the engaging portion to the connector or to the engaging portion of the adjacent intermediate component.

According to an embodiment of the present invention, the upper lid and the lower lid are provided with plural first fixing elements corresponds to interlock with the at least one locking portions of the plural bonding components.

According to an embodiment of the present invention, an internal rim of each of the two lateral components is provided with plural accessorial locking portions, and each of the two lids is provided with plural second fixing elements corresponding to the accessorial locking portions.

According to an embodiment of the present invention, each of the plural bonding components is provided with at least one perforation on an end surface thereof to maintain an interconnected state of an internal space of the present invention.

According to an embodiment of the present invention, external sides of junctions between the two lateral components, the plural intermediate components, the plural bonding components, and the two lids are processed by welding for strengthening the connection.

According to an embodiment of the present invention, the lateral components, the intermediate components, the bonding components are made of aluminum, magnesium or aluminum-magnesium alloy.

### BRIEF DESCRIPTION OF THE DRAWINGS

FIG. 1 is a first exploded stereogram of the present invention;

FIG. 2 is a second exploded stereogram of the present invention;

FIG. 3 is a stereogram of the present invention;

FIG. 4 is a sectional view of the present invention.

### DETAILED DESCRIPTION OF THE PREFERRED EMBODIMENT

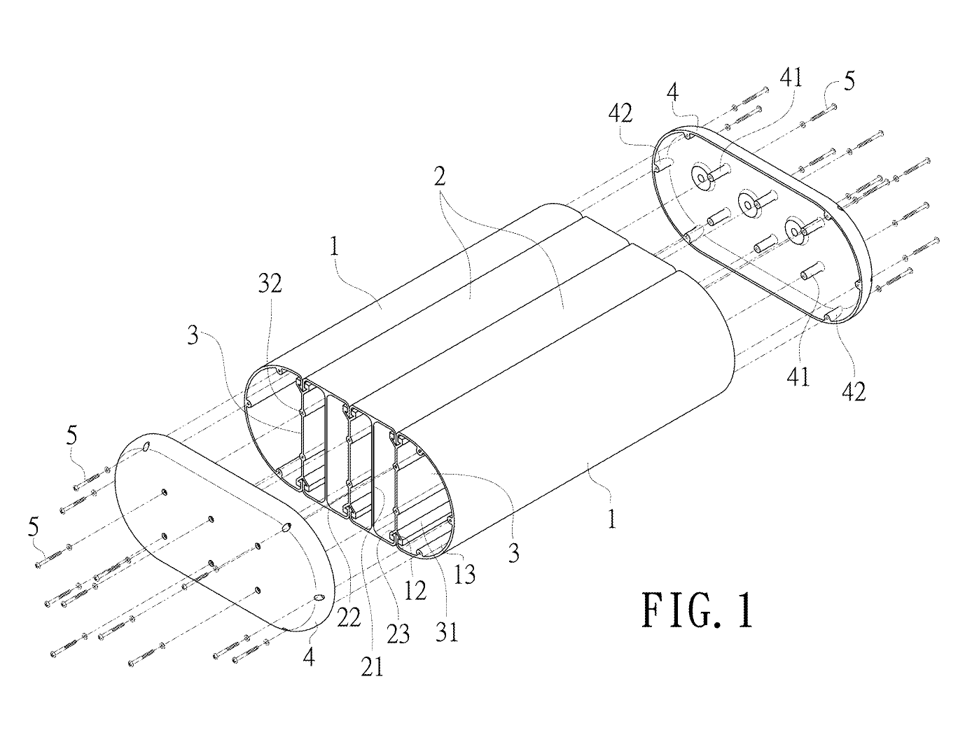

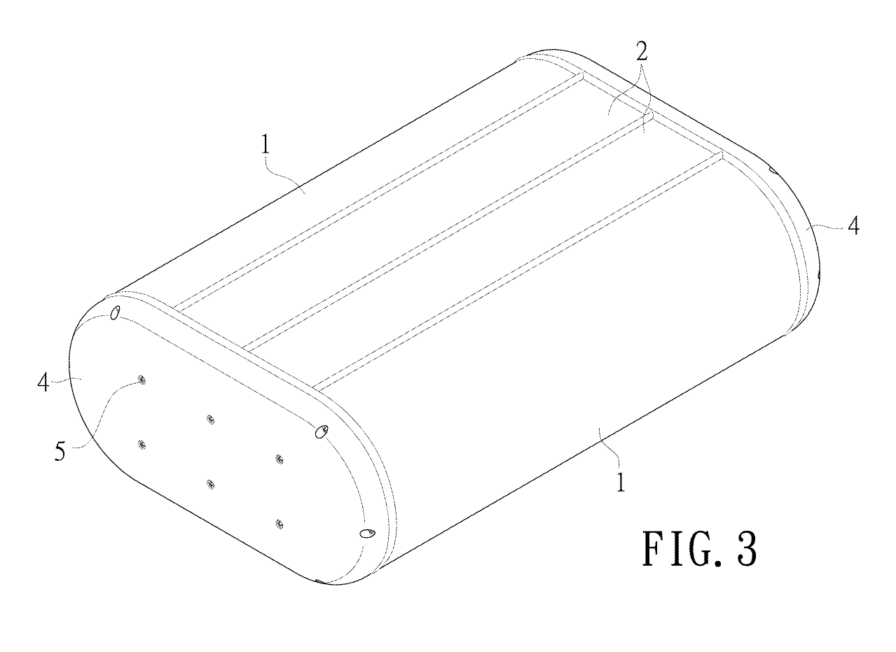

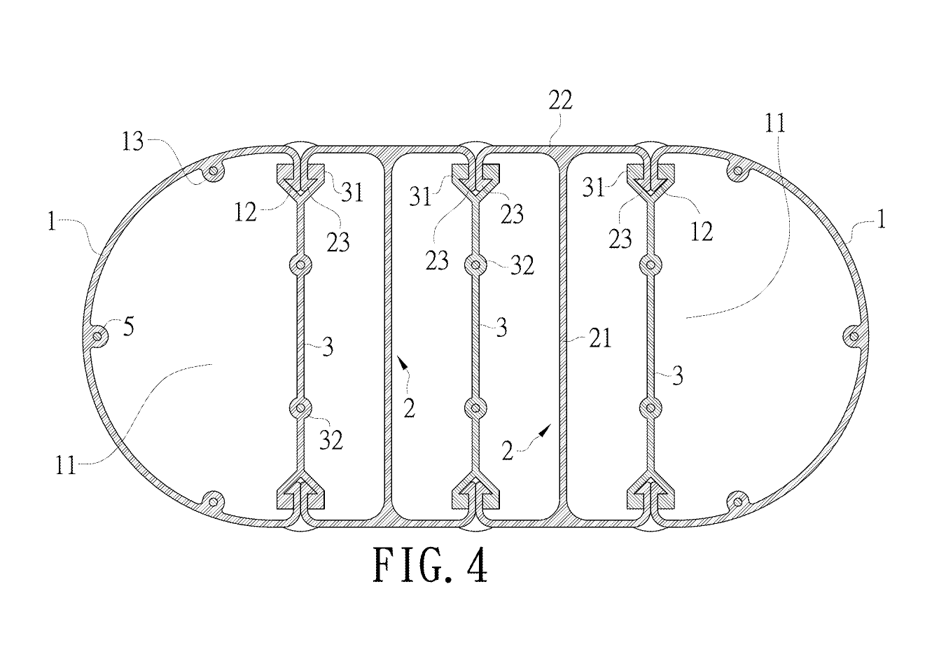

Referring to FIG. 1 to FIG. 4, two exploded stereograms, a stereogram and a sectional view of the gas steel container structure for cars of the present invention are disclosed. The present invention comprises two lateral components, plural intermediate components, plural bonding components and two lids.

Each of the two lateral components (1) has an opening (11) and two connectors (12) disposed on two sides of the opening (11) respectively.

The plural intermediate components (2) are disposed between the two lateral components (1), and each of the plural intermediate components (2) has a central partition (21), two outboards (22) disposed at two sides of the central partition (21), and two engaging portions (23) disposed at two sides of each outboard (22) and corresponding to the two connectors (12) or to the two engaging portions (23) of another intermediate component (2).

The plural bonding components (3) are provided for connecting the plural intermediate components (2) to the two lateral components (1) or connecting two adjacent intermediate components (2) to each other. Each of the plural bonding components (3) has two linkage portions (31) at two sides thereof and at least one locking portion (32) disposed between the two linkage portions (31). Each of the two linkage portions (31) receives and links the engaging portion (23) to the connector (12) or to the engaging portion (23) of the adjacent intermediate component (2).

The two lids (4) include an upper lid (4) and a lower lid (4) for respectively covering a top side and a bottom side of the lateral components (1) assembled with the plural intermediate components (2), wherein the upper lid (4) and the lower lid (4) are provided with plural first fixing elements (41) to interlock with the at least one locking portions (32) correspondingly.

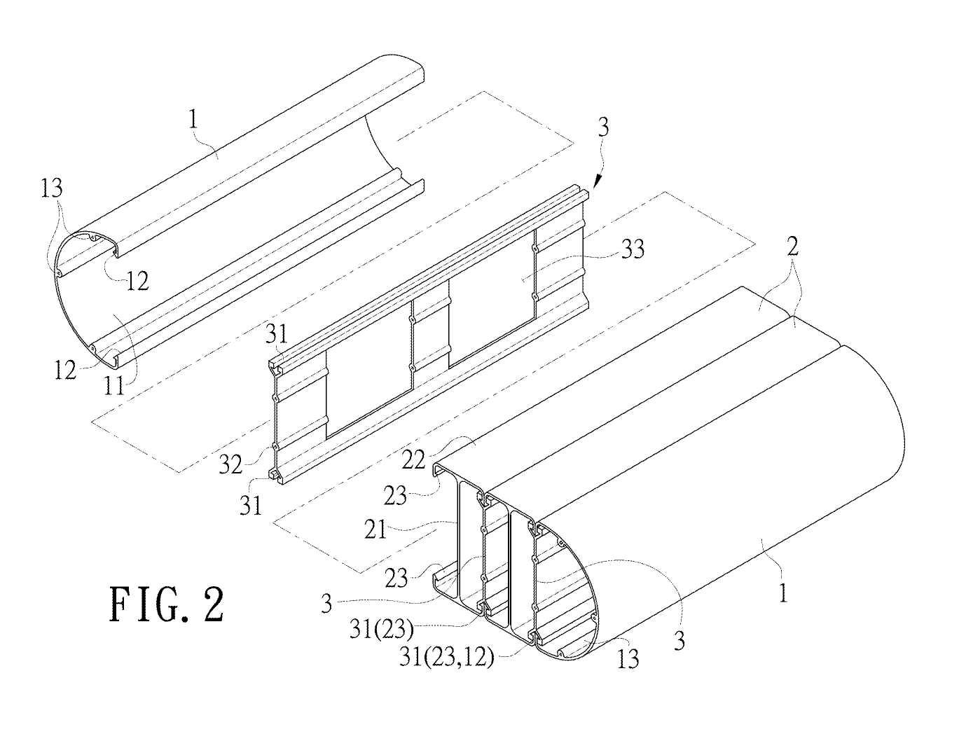

As shown in FIG. 1 to FIG. 4, in the production of the gas steel container structure for cars, aluminum, magnesium or aluminum-magnesium alloy are chosen for manufacturing the two lateral components (1), the plural intermediate components (2), the plural bonding components (3), and the two lids (4). Furthermore, the amount of the intermediate components (2) is deter mined based on the required volume of the gas steel container structure to be produced. For instance, a gas steel container structure for cars having two layers of intermediate components (2) is disclosed in FIG. 1 and FIG. 2 as an exemplary embodiment for explanation.

As shown in FIG. 1 and FIG. 2, the two connectors (12) disposed on two sides of the opening (11) of one lateral component (1) are corresponding to the engaging portion (23) at one side of the intermediate component (2). The connectors (12) and the corresponding engaging portion (23) are inserted into a linkage portion (31) of the bonding component (3) and are accommodated by the linkage portion (31). Then, the lateral component (1) and the intermediate components (2) ate linked and fixed to each other by the bonding components (3). Next, another engaging portion (23) at the other side of the intermediate components (2) is corresponding to an engaging portion (23) on another intermediate component (2), and the two corresponding engaging portions (23) are inserted into the linkage portions (31) of another bonding component (3) and are accommodated by the linkage portion (31). Thus, the two intermediate components (2) are linked and fixed to each other by the bonding component (3). After that, the other lateral component (1) is linked and fixed to the intermediate component (2) by the same process described above.

After the lateral components (1) are assembled to the intermediate components (2), a top side and a bottom side of the lateral components (1) along with the intermediate components (2) and the bonding components (3) are covered by the upper lid (4) and the lower lid (4) thereof by the fixing elements (41) interlocking with the locking portions (32) of the bonding components (3) and by plural bolt assemblies (5) further locking on the locking portions (32). To further stabilize the connection of the upper lid (4) and the lower lid (4), an internal rim of the lateral component (1) is provided with plural accessorial locking portions (13), and the upper lid (4) and the lower lid (4) are provided with plural second fixing elements (42) to correspondingly interlock with the accessorial locking portions (13) by the bolt assemblies (5).

In addition, an end surface on the bonding component (3) is provided with at least one perforation (33) to maintain an interconnected state and in an internal space filled with gas of the present invention. The design of the perforation (33) can also reduce the weight and the volume of the gas steel container structure for cars and reduce production costs without affecting structural strength of the present invention.

Moreover, the external sides of junctions between the two lateral components (1), the plural intermediate components (2), the plural bonding components (3), and the two lids (4) are processed by welding to strengthen the connection and the structural strength in avoidance of air leaks in use so that efficacy of safety are achieved.

From the description above, it can be known that this invention, compared with the modem techniques, has the following advantages:

1. The design of the bonding components linking and fixing the corresponding lateral components and intermediate components provides a high structural strength in avoidance of air leaks in use.

2. The wilding processes at the external sides of junctions between the two lateral components, the plural intermediate components, the plural bonding components, and the two lids can strengthen the connection and the structural strength of the present invention in avoidance of air leaks in use and provide safety effects in use.

What is claimed is:

1. A gas steel container structure for cars, comprising:
two lateral components, each having an opening and two connectors are disposed on two sides of the opening respectively;
plural intermediate components disposed between the two lateral components, each having a central partition, two outboards disposed at two sides of the central partition, and two engaging portions disposed at two sides of each outboard, wherein the two engaging portions are corresponding to the two connectors or to the two engaging portions of another intermediate component;
plural bonding components for connecting the plural intermediate components to the two lateral components or connecting to adjacent intermediate component to each other, each having two linkage portions at two sides thereof and at least one locking portion disposed between the two linkage portions, wherein each of the two linkage portions receives and links the engaging portion to the connector or to the engaging portion of the adjacent intermediate component; and
two lids, having an upper lid and a lower lid for respectively covering a top side and a bottom side of the lateral components assembled with the plural intermediate components, wherein the upper lid and the lower lid are provided with plural first fixing elements to interlock with the at least one locking portion correspondingly.

2. As the gas steel container structure for cars claimed in claim 1, wherein an internal rim of each of the two lateral components is provided with plural accessorial locking portions, and each of the two lids is provided with plural second fixing elements to interlock with the accessorial locking portions correspondingly.

3. As the gas steel container structure for cars claimed in claim 1, wherein each of the plural bonding components is provided with at least one perforation on an end surface thereof.

4. As the gas steel container structure for cars claimed in claim 2, plural bolt assemblies are further provided to insert into the plural first fixing elements of the two lids and lock on the at least one locking portion of the plural bonding components, or to insert into the plural second fixing elements of the two lids and lock on the plural accessorial locking portions of the two lateral components.

5. As the gas steel container structure for cars claimed in claim 2, wherein each of the plural bonding components is provided with at least one perforation on an end surface thereof.

6. As the gas steel container structure for cars claimed in claim 4, wherein each of the plural bonding components is provided with at least one perforation on an end surface thereof.

7. As the gas steel container structure for cars claimed in claim 6, wherein junctions of the two lateral components, the plural intermediate components, the plural bonding components, and the two lids are processed by welding.

8. As the gas steel container structure for cars claimed in claim 7, wherein the lateral components, the plural intermediate components, the plural bonding, components, and the two lids are made of aluminum, magnesium or aluminum-magnesium alloy.
